(19) United States
(12) Patent Application Publication
(10) Pub. No.: US 2015/0356232 A1
(43) Pub. Date: Dec. 10, 2015

(54) Method and System for Generating a Circuit Design, Method for Calibration of an Inspection Apparatus and Method for Process Control and Yield Management

(71) Applicant: Synopsys, Inc., Mountain View, CA (US)

(72) Inventors: Lars Henning Bomholt, Feusisberg (CH); Xi-Wei Lin, Fremont, CA (US); John Kim, Santa Clara, CA (US)

(21) Appl. No.: 14/721,988

(22) Filed: May 26, 2015

Related U.S. Application Data
(60) Provisional application No. 62/009,063, filed on Jun. 6, 2014.

(51) Int. Cl. G06F 17/50

(52) U.S. Cl. CPC G06F 17/5081; G06F 17/5072; G06F 17/5077; G06F 2217/06; G06F 2217/12

(57) ABSTRACT

A method for generating a circuit design of an integrated circuit, the circuit design comprising a functional area (FA) and a non-functional area is provided. The method comprises the steps of providing a description of a test cell (TC) to an electronic design automation (EDA) tool and inserting the test cell (TC) into the circuit design. Therein, the description of the test cell (TC) comprises a description of a test structure (HS) and the test structure (HS) is designed to be sensitive to variations of a manufacturing process. Furthermore, the test cell (TC) is inserted into a non-functional area and the inserting is performed automatically by the EDA tool. The test structure (HS) is intentionally designed to be sensitive to variations of the manufacturing process, in contrast to regular structures within the circuit description.

### CROSS REFERENCE TO RELATED APPLICATIONS

This application claims the benefit of U.S. Provisional Application No. 62/009,063, filed Jun. 6, 2014, which is incorporated by reference in its entirety.

### BACKGROUND

Mask inspection, wafer inspection and related monitoring and review processes are essential steps to semiconductor manufacturing. The manufacturing process is complex and requires high precision, increasingly so as the size of structures is shrinking with progressing technology nodes. At the same time, chip complexity, that is for example the number of structures to monitor, increases. Inspection and yield analysis processes need to keep up with these requirements. Inspection increasingly benefits from design information, as inspection strategies and inspection settings have to be adapted to the design to be capable of obtaining relevant information.

Scribeline structures have been used for this purpose, but the scribeline has some disadvantages. For example the scribeline is crowded with other test structures. Also the scribeline may not be part of the circuit design and is located between chips in a reticle or at a periphery of the reticle. Scribelines therefore severely restrict the placement possibilities and may not fully represent the actual design contexts.

### SUMMARY

The disclosure relates to a method and a system for generating a circuit design of an integrated circuit, IC, in particular using an electronic design automation, EDA, tool. Furthermore, methods for calibration of an inspection apparatus and for process control and yield management are provided which are based said method for generating a circuit design.

The disclosure addresses the problem of efficiently gathering for example quality data for yield management and process window qualification during inspection. It addresses the difficulty of finding relevant inspection items in a growing amount of data by not only opportunistically finding items, but creating them at or before a tape-out stage of the circuit design and using them for example for calibration, process control and yield analysis.

The disclosed configuration provides an improved concept for mask inspection, wafer inspection and related monitoring and review processes. This is achieved by the subject-matter of the independent claims. Developments, embodiments and implementations are subject-matter of the dependent claims.

According to the improved concept a method for generating a circuit design of an integrated circuit is provided, wherein the circuit design comprises at least one functional area and at least one non-functional area. The method comprises the steps of providing a description of at least one test cell to an EDA tool and inserting the at least one test cell into the circuit design.

Therein, the description of the test cell comprises a description of at least one test structure and the at least one test structure is designed to be sensitive to variations in a manufacturing process. Furthermore, the at least one test cell is inserted into one of the at least one non-functional area and the inserting is performed automatically by the EDA tool.

It is emphasized, that the at least one test structure is intentionally designed to be sensitive to variations of the manufacturing process, in contrast to regular structures within the circuit description that may, in particular unintentionally, also exhibit a certain sensitivity to manufacturing processes.

In some implementations of the method the at least one test cell is inserted into a part of the at least one non-functional area that is accessible for inspection during a metrology step and/or a review step. In particular the part of the at least one non-functional area may be accessible for inspection during a mask inspection and/or a wafer inspection. Furthermore, the at least one test structure is designed to indicate, in the metrology step and/or the review step, the variations of the manufacturing process.

In some implementations of the method the description of the at least one test cell is comprised by a cell library, In particular a standard cell library, provided to the EDA tool.

A standard cell library is for example a predefined set of cells that enable a logical operation necessary to implement a function in an IC design. Such a cell library is for example provided by a 3rd party library provider, so that a design team no longer has to design their own libraries. A design process may be implemented for example through a synthesis step in a synthesis tool that automatically selects a correct standard cell element that may execute the desired operation for example within bounds of power, performance and area. After placement of the instances, a reasonably large portion of the chip area would for example have empty spaces, which are left so that routing can take place or enable engineering change orders, ECOs, to a design without a large movement of many of these instances. Since these spaces may for example not be left empty, for example filler cells providing no actual functional operation may be used to keep for example density and/or other design rules from being violated. It may for example be useful to place something useful in these filler cells other than non-functional cells, namely for example the at least one test cell.

According to the improved concept also a method for calibrating an inspection apparatus is provided. The method comprises generating a circuit design utilizing a method according to the improved concept and detecting an irregularity related to one of the at least one test cell.

In some implementations of the method for calibrating an inspection apparatus, the inspection apparatus is an optical inspection apparatus for performing a mask inspection or a wafer inspection.

In some implementations the method for calibrating an inspection apparatus further comprises calibrating the inspection apparatus depending on the detected irregularity and/or a coordinate of the one of the at least one test cell.

According to the improved concept, also a method for process control and/or for yield management is provided. Such method comprises generating a circuit design utilizing a method according to the improved concept. Furthermore, the method comprises detecting an irregularity related to one of the at least one test cell and detecting an irregularity in a process for manufacturing the IC or in a process for manufacturing a mask for manufacturing the IC based on the detecting of the irregularity related to the one of the at least one test cell.

### BRIEF DESCRIPTION OF THE DRAWINGS

The improved concept will be described with respect to specific embodiments, and reference will be made to the drawings, in which:

FIG. 1 shows a simplified representation of an illustrative integrated circuit design flow.

FIG. 2 schematically shows a circuit design of an integrated circuit with functional areas and non-functional area comprising a test cell with an artificial hot-spot.

FIG. 3A schematically shows an example for a structure with a violation of a design rule.

FIG. 3B schematically shows an example for a structure where a violation of a design rule is fixed.

### DETAILED DESCRIPTION

Components that are functionally identical or have an identical effect may be denoted by identical references. Identical or effectively identical components may be described only with respect to the figure where they occur first, their description is not necessarily repeated in successive figures.

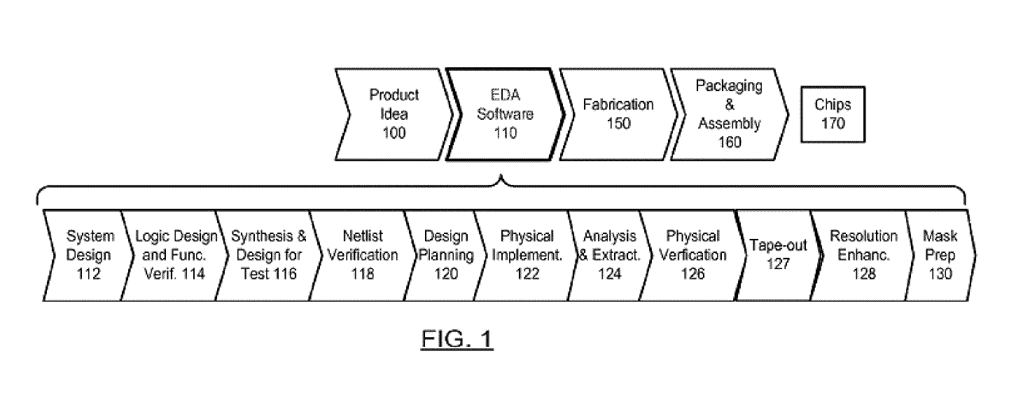

FIG. 1 shows a simplified representation of an illustrative IC design flow. At a high level, the process starts with the product idea (step 100) and is realized in an EDA software design process (step 110). When the design is finalized, it can be taped-out (step 127). At some point after tape-out, the fabrication process (step 150) and packaging and assembly processes (step 160) occur, resulting ultimately in finished IC chips (result 170).

The EDA software design process (step 110) itself is composed of a number of steps 112-130, shown in linear fashion for simplicity. In an actual integrated circuit design process, the particular design might have to go back through steps until certain tests are passed. Similarly, in any actual design process, these steps may occur in different orders and combinations. This description is therefore provided by way of context and general explanation rather than as a specific, or recommended, design flow for a particular integrated circuit.

A brief description of the component steps of the EDA software design process (step 110) will now be provided.

System design (step 112): The designers describe the functionality that they want to implement, they can perform what-if planning to refine functionality, check costs, etc. Hardware-software architecture partitioning can occur at this stage. Example EDA software products from Synopsys, Inc. that can be used at this step include Model Architect, Saber, System Studio, and DesignWare® products.

Logic design and functional verification (step 114): At this stage, a VHDL or Verilog code for modules in the system is written and the design is checked for functional accuracy. More specifically, the design is checked to ensure that it produces correct outputs in response to particular input stimuli. Example EDA software products from Synopsys, Inc. that can be used at this step include VCS, VERA, DesignWare®, Magellan, Formality, ESP and LEDA products.

Synthesis and design for test (step 116): Here, the VHDL/Verilog is translated to a netlist. The netlist can be optimized for the arget technology. Additionally, the design and implementation of tests to permit checking of the finished chip occurs. Example EDA software products from Synopsys, Inc. that can be used at this step include Design Compiler®, Physical Compiler, DFT Compiler, Power Compiler, FPGA Compiler, TetraMAX, and DesignWare® products.

Netlist verification (step 118): At this step, the netlist is checked for compliance with timing constraints and for correspondence with the VHDL/Verilog source code. Example EDA software products from Synopsys, Inc. that can be used at this step include Formality, PrimeTime, and VCS products.

Design planning (step 120): Here, an overall floorplan for the chip is constructed and analyzed for timing and top-level routing. Example EDA software products from Synopsys, Inc. that can be used at this step include Astro and Custom Designer products.

Physical implementation (step 122): The placement (positioning of circuit elements) and routing (connection of the same) occurs at this step (place-and-route process). Example EDA software products from Synopsys, Inc. that can be used at this step include the Astro, IC Compiler, and Custom Designer products. Aspects of the invention can be performed during this step 122.

Analysis and extraction (step 124): At this step, the circuit function is verified at a transistor level, this in turn permits what-if refinement. Example EDA software products from Synopsys, Inc. that can be used at this step include AstroRail, PrimeRail, PrimeTime, and Star-RCXT products.

Physical verification (step 126): At this step various checking functions are performed to ensure correctness for: manufacturing, electrical issues, lithographic issues, and circuitry. Example EDA software products from Synopsys, Inc. that can be used at this step include the Hercules product. Aspects of the invention can be performed during this step 126 as well.

Tape-out (step 127): This step provides the “tape-out” data to be used (after lithographic enhancements are applied if appropriate) for production of masks for lithographic use to produce finished chips. Example EDA software products from Synopsys, Inc. that can be used at this step include the IC Compiler and Custom Designer families of products.

Resolution enhancement (step 128): This step involves geometric manipulations of the layout to improve manufacturability of the design. This step for example includes optical proximity correction, OPC. Example EDA software products from Synopsys, Inc. that can be used at this step include Proteus, ProteusAF, and PSMGen products.

Mask data preparation (step 130): This step provides mask-making-ready “tape-out” data for production of masks for lithographic use to produce finished chips. Example EDA software products from Synopsys, Inc. that can be used at this step include the CATS® family of products. Often this step includes partitioning or fracturing non-rectangular shaped islands into rectangles.

With respect to generating a circuit design so-called hot-spots are of particular interest. The term hot-spots refers to locations in the chip that are particularly challenging to manufacture, which makes them also valuable targets for inspection and yield management.

Design hot-spots are difficult to manufacture due to high likelihood of deviation from the intended structures or sensitivity to variation in processes, for example lithography processes but also other process steps. If these design hot-spots create a defect, it commonly affects yield. While design hot-spots represent the most critical locations in a design and therefore are of particular interest, commonly they are not ideal for acquiring data targeting yield improvement, as the goal of design, process, and supporting technologies such as mask synthesis is to make the design hot-spots robust against process variation.

A scribeline test structure is for example a testable or measurable feature that exists in a scribe area between two product dies. Such areas are located in the scribe lane of a wafer and will be destroyed for example during wafer dicing and therefore only exist while in full wafer form. After dicing the scribe areas are no longer available for testing or measuring.

While scribeline structures are currently sometimes used as specific process monitoring structures, scribelines are located outside the chip area in the area between the various chips, so their actual behavior with respect to the manufacturing processes may be different than that of chip areas. Also, scribelines are used for many other purposes, and scribeline space is valuable, so it is seen as beneficial to place inspection structures into the chip area.

Another area of difficulty is that inline optical inspections commonly have an inherent inaccuracy in the coordinates that are reported per defect. This information is important when performing overlay correlations to failures in the design. Current inaccuracies are for example in the order of 1 μm but could be more depending on the tool type, as well as on uncertainties about the inspection origins.

According to the improved concept, artificial hot-spots HS are used as test cells and inserted into the circuit design for inspection, process control and/or yield management.

In this way, more suitable structures for inspection than design hot-spots (hot-spots that occur in functional parts of the design) are generated on the chip. These additional structures are denoted as artificial hot-spots HS.

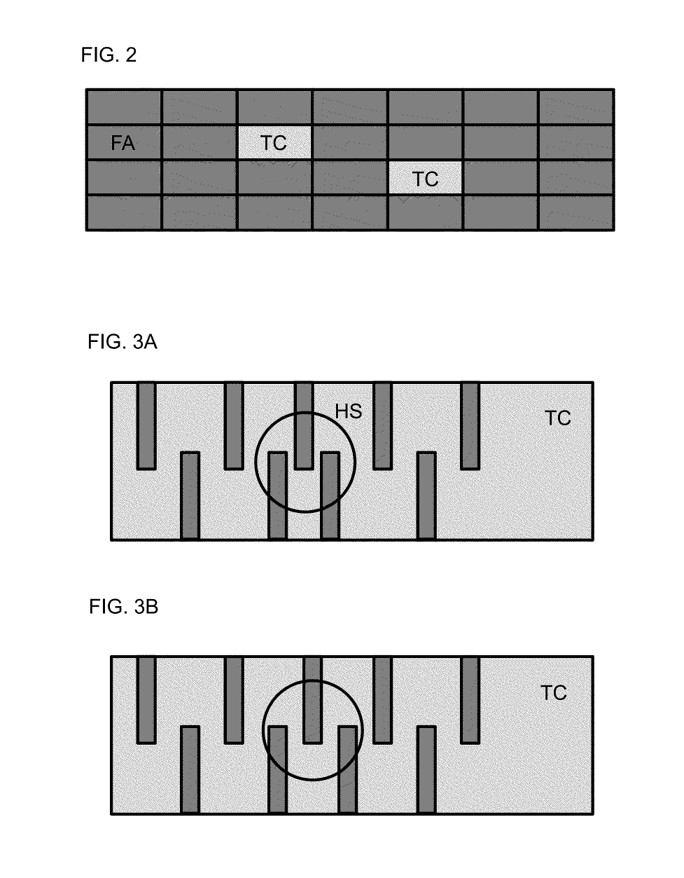

FIG. 2 schematically shows a circuit design of an integrated circuit with functional areas FA and non-functional areas comprising a test cell TC with an artificial hot-spot HS. Functional areas FA are shaded in dark grey, the two rectangular areas shaded in lighter grey represent test cells TC comprising artificial hot spots HS.

The target of process and design rules is to keep design hot-spots as insensitive as possible to process variations. If design hot-spots create a defect, it affects yield. Artificial hot-spots HS are created to have no function in the design and consequently may be engineered to be more sensitive to process variations, and improve the usefulness of inspection data for process control. If the artificial hot-spots HS generate defects this does not affect yield because the defect is non-critical for the product.

Two possibilities for placing artificial hot-spots HS are to place them in fill areas or in non-functional library cells (both could be regarded as dummy areas or non-functional areas).

A fill area is a space in a cell array of functional elements. It may for example not be allowed to leave a completely blank space in a design, so this space may be filled with a non-functional cell. In such areas, non-functional filler cells may for example be placed that may include artificial hot-spots HS. The filler areas may be structurally the same as functional areas FA, but they may not be active devices that commonly execute operations.

The test cells TC are designed to be sensitive to process variations, with the target that if they fail they do not create a critical defect.

Filler cells may have no functionality. Their only purpose may be that no gap is left in the density of a design. Due to modern manufacturing requirements, pattern variation may be reduced if all the patterns and pattern densities are similar. Leaving a hole in an area of the design may negatively affect the adjacent layout patterns and cause excessive variation. Fill areas are not directly critical to the design and to the design performance, although they are relevant to the processes and manufacturing yield due to said effects.

In order to enhance the sensitivity to process variation, the artificial hot-spots HS may for example be deliberately designed with design rule violations or other critical features. Marker layers or cell exclusion may be used during physical verification (for example layout versus schematic, LVS, and/or design rule checking, DRC) to avoid false errors.

A marker layer is for example a layer in a GDS that may only identify a region for a special operation, or to block it from some operation. For example, one may have a “no OPC” marker layer for an area, which indicates that any structures within that area will not have OPC applied. During the design tapeout stage, automated rule checking systems like DRC and LVS may be used to ensure for example that no design violations have been made and all electrical connections are correct according to the schematics. Automated rule decks may be required in modern designs due to the size of designs and number of complex rules that need to be checked.

Different types of layout patterns may be designed to target inspection for different types of process variations or different design characteristics (for example cell array, datapath, random logic, analog).

The fill areas may be large (for example up to 30% of a layer) and are of little value. Manufacturing defects in fill areas also have little impact. The artificial hot-spots HS may for example be added in the fill areas during the chip implementation, in design for manufacturability, DFM, steps in the tape-out process, during chip finishing or during sign-off before tape-out.

Chip Implementation is a process of placing and connecting for example all operational elements according to a schematics and design level description of a design, following the rules of physical layout. Design for manufacturability, DFM, and chip finishing are design steps that may be taken after the implementation is completed to make small modifications to the layout for example such that yield is improved. An example of such operations may be where a single via is placed connected an upper and a lower wire. The via is then for example replaced with a double via if there is space available for reliability of connection. Once all of these operations are completed and the design and implementation are completed, tapeout may occur which sends the design to be processed for mask making and fabrication.

In layers where there may be little fill space, such as the front-end layers, there is a proportion of spare cells, that is redundant logic library cells that are not actively connected to the design, but provide the capability of fixing problems either late in the design process or during chip respin, by connecting them to the circuitry to correct faulty functionality without having to change the logic library cell placement and front-end layers. Front end layers are for example layers that are involved in active device fabrication. These are for example active, poly and contact layers. Layers that form interconnects (like metal layers and via layers) are for example referred to as back end layers.

Adding artificial hot-spots HS as test cells TC integrated into non-functional library cells to the library represent an alternative to placement in the fill areas. The non-functional library cells can be added as part of the spare cell placement. When structures in form of non-functional library cells are used, they may for example be inserted into the circuit design during a place-and-route process. The structure types may for example be selected to represent prevalent cell types (for example most frequently used flip-flops) or critical circuitry (for example input/output cells or analog blocks) in the circuit design. They may for example be placed at random positions or adjacent to areas of critical interests for yield management.

There are several possibilities how the artificial hot-spots HS acting as test cells TC may be engineered or designed to be particularly sensitive to process variations and therefore of particular value. Some examples for structures in artificial hot-spots HS are listed in the following. However, the list does not make any claim to be complete. In particular other structures could be used within artificial hot-spots HS, as long as they are sensitive to variations of a process in view. Several types of structures may be used for a circuit design.

### i) Structures Violating Design Rules.

A design rule is for example a set of rules for a given semiconductor manufacturing process that defines how a design may be implemented such that it may be correctly manufactured. Each process in a fab may have its own design rules. Such design rules may for example comprise rules for line-to-line separation, tip-to-tip separation, line-to-tip separation or others. Resulting artificial hot-spots HS are likely to be very sensitive to and strongly affected by the manufacturing process.

An example for a structure violating a design rule is schematically shown in FIG. 3A. The encircled area shows three rectangular structures with distances from each other being smaller than distances between the remaining rectangular structures. The smaller distances may for example violate a line-to-line separation rule and/or other design rules.

ii) Structures that are Protected from OPC During a Physical Verification Process.

A layout feature would for example normally be corrected by adding for example shapes to ensure that it may be printed correctly. An example is schematically shown in FIG. 3B. A structure similar to the one shown in FIG. 3A is displayed. However, the smaller distances between the encircled structures have been increased, for example to comply with design rules.

An artificial hot-spot HS structure may be blocked from having such correction applied for example during OPC. This would for example make this feature more susceptible to failure on a wafer. Physical verification processes are for example a group of steps taken during and after chip implementation is completed to ensure that no design rules were violated. For example DRC is one of the most common physical verification operations.

The test cells TC with artificial hot-spots HS may for example be excluded from LVS/DRC runs to avoid being flagged for possible violations. The exclusion may for example be done by using cell names or markup layers. Such artificial hot spots HS are for example sensitive to lithographic variations in the manufacturing process.

iii) Structures Violating Mask Manufacturing Rules.

Such artificial hot-spots HS may be particularly sensitive to variations in the mask manufacturing process. Mask Manufacturing rules are similar in concept to design rules but designed to protect the mask making process. Mask rule checking, MRC may be used to flag for example minimum width and space violations for example in design data, fractured E-beam data, inspection data, PG data, or jobdecks.

### iv) Structures Similar to Calibration Structures in Lithographic Modeling.

Such structures may be designed by purposely laying out a pattern that is known to be a low yielding structure. Artificial hot-spots HS of such type may allow to quantitatively assess lithographic performance, or quantitatively assess the impact of long-range effects within a layout.

v) Structures that are Known to be Sensitive to Manufacturing and are Therefore Typically not Used in the Design.
vi) Structures Similar to Structures Known to be Difficult to Manufacture, as they have been Found in Yield Analysis.

Such structures may conform to all design rules, but still be problematic. As such structures may still be used in manufacturing, they may, however, also be found in many designs. The use within artificial hot-spots HS may nevertheless make yield analysis less opportunistic and more consistent across different products.

The artificial hot-spots HS may for example be used to make global grid, magnification, skew and/or rotation corrections to the coordinate systems to ensure that they align to the designed wafer grid, so that accurate correlations can be made. For example, a structure as sketched in FIG. 3A may possess a relatively high probability for failing. Coordinates of such structures may be known and for example be utilized for calibration.

Calibration may work for example by reading the original coordinates in, identifying any systematic errors and then correcting them to remove the systematic errors. This would be applicable for any yield or defect system which uses the coordinates of artificial hot-spots HS.

Artificial hot-spots HS may for example also be used to monitor process windows of a process step, since they are more sensitive to variations than standard features.

The hot-spot locations, be it from natural design hot-spots or from artificial hot-spots HS, are available for inspection during mask inspection, wafer inspection, and related metrology and review steps. Artificial hot-spots HS, being particularly sensitive to variations, provide relevant data for process monitoring and yield analysis. An example for process monitoring may be critical dimension, CD, monitoring for a layer. Yield Analysis is a very broad class of analysis where product wafers are tested for functionality and analyzed for sources of yield loss.

During inspection, hot-spot sites will likely show up as failures and if they are in a known area of the artificial hot-spots HS, the inspection tool may for example register them as such, so that they can be used for calibration points later both for overlay to functional failures, but also to align scanning electron microscopy review stations for example automatically.

A further possibility is to mark sites of artificial hot-spots HS during inspection regardless of failures, so that they can be used for calibration later. They may for example be tagged with a specific classification code so that the end user can use this to identify these as calibration features rather than failures.

A yield analysis tool may for example use these values automatically incorporating an overlay model to make corrections to the coordinates of the defects. The gathered data may also be used for yield improvement, in particular for design-based yield improvement. The described methods are consistent with established design and mask synthesis methodologies, making it relatively easy to implement.

What is claimed is:

1. A method for generating a circuit design of an integrated circuit (IC), the circuit design comprising at least one functional area (FA) and at least one non-functional area, the method comprising
providing a description of at least one test cell to an electronic design automation tool, the description of the test cell comprising a description of at least one test structure and the at least one test structure is designed to be sensitive to variations of a manufacturing process; and
inserting the at least one test cell into the circuit design, wherein the at least one test cell is inserted into one of the at least one non-functional area; and the inserting is performed automatically by the EDA tool.

2. The method according to claim 1, wherein the manufacturing process is a process for manufacturing the IC or for manufacturing a mask for manufacturing the IC.

3. The method according to claim 1, wherein
the at least one test cell is inserted into a part of the at least one of a non-functional area being accessible for inspection during a metrology step and a review step, the insertion during one of a mask inspection and a wafer inspection; and
the at least one test structure is designed to indicate variations of the manufacturing process.

4. The method according to claim 1, wherein a defect of the at least one test structure caused by the variations does not affect the functionality of the IC.

5. The method according to claim 1, wherein the at least one test cell is inserted into a chip area of the circuit design, in particular is not inserted into a scribeline of the circuit design.

6. The method according to claim 1, further comprising a place-and-route process and wherein the inserting of a first of the at least one test cell is carried out during the place-and-route process.

7. The method according to claim 6, wherein the first of the least one test cell is inserted into a non-functional library cell of the design.

8. The method according to claim 1, further comprising:
a place-and-route process; and
a tape-out process,
wherein the inserting of a second of the at least one test cell is carried out after the place-and-route process and before the tape-out process.

9. The method according to claim 8, wherein the second of the at least one test cell is inserted into a fill area of the circuit design.

10. The method according to claim 1, wherein the at least one test structure is designed to be sensitive to variations of the manufacturing process by violating at least one design rule.

11. The method according to claim 1, further comprising at least one of an optical proximity correction (OPC) process, a mask error correction, MEC, process, a mask data preparation (MDP) process, and wherein the at least one test structure comprises a structure that is not affected by at least one of the OPC process, the MEC process and the MDP process.

12. The method according to claim 1, wherein the at least one test structure is designed to be sensitive to variations of the manufacturing process by violating at least one mask manufacturing rule.

13. The method according to claim 1, wherein the at least one test structure emulates a structure for assessing a lithographic performance.

14. The method according to claim 1, wherein the at least one test structure lack presence in the functional area of the circuit design.

15. The method according to claim 1, wherein the at least one test structure represents a at least one of a prevalent cell type and a critical circuitry of the design.

16. The method according to claim 1, further comprising a physical verification process which lacks involvement in at least one of a checking of the at least one test structure and a detected irregularity related to the at least one test structure being ignored.

17. A method for calibrating an inspection apparatus comprising:
generating a circuit design utilizing the method according to claim 1; and
detecting an irregularity related to one of the at least one test cell.

18. The method according to claim 17, further comprising calibrating the inspection apparatus depending on at least one of the detected irregularity and a coordinate of the one of the at least one test cell.

19. The method according to claim 17, further comprising at least one of a magnification correction, a grid correction, a skew correction or a rotation correction.

20. A method comprising:
generating a circuit design, the circuit design generated by
providing a description of at least one test cell to an electronic design automation tool, the description of the test cell comprising a description of at least one test structure and the at least one test structure is designed to be sensitive to variations of a manufacturing process, and
inserting the at least one test cell into the circuit design, wherein the at least one test cell is inserted into one of the at least one non-functional area; and the inserting is performed automatically by the EDA tool;
detecting an irregularity related to one of the at least one test cell; and
detecting an irregularity in a process for manufacturing the IC or in a process for manufacturing a mask for manufacturing the IC based on the detecting of the irregularity related to the one of the at least one test cell.

21. A system for generating a circuit design of an IC, the circuit design comprising at least one functional area and at least one non-functional area, the system comprising:
a processor being adapted to automatically insert at least one test cell into one of the at least one non-functional area of the circuit design, a description of the at least one test cell is comprised by a cell library being provided to the system, the description of the test cell comprises a description of at least one test structure, and
the at least one test structure is designed to be sensitive to variations of a manufacturing process.

22. A computer program product comprising a code, said code when executed by at least one processor, causes the at least one processor to:
provide a description of at least one test cell to an electronic design automation (EDA) tool, the description of the test cell comprising a description of at least one test structure and the at least one test structure is designed to be sensitive to variations of a manufacturing process; and
insert the at least one test cell into the circuit design, wherein the at least one test cell is inserted into one of the at least one non-functional area; and the inserting is performed automatically by the EDA tool.

23. The computer program product according to claim 22, wherein the manufacturing process is a process for manufacturing the IC or for manufacturing a mask for manufacturing the IC.

24. The computer program product according to claim 22, wherein
the at least one test cell is inserted into a part of the at least one non-functional area being accessible for inspection during a metrology step and a review step, the insertion during at least one of a mask inspection and a wafer inspection; and
the at least one test structure is designed to indicate, in the metrology step and/or the review step, the variations of the manufacturing process.

25. The computer program product according to claim 22, wherein a defect of the at least one test structure caused by the variations lacks impacting of functionality of the IC.

26. The computer program product according to claim 22, wherein the at least one test cell is inserted into a chip area of the circuit design.

27. The computer program product according to claim 22, further comprising a place-and-route process and wherein the inserting of a first of the at least one test cell is carried out during the place-and-route process.

28. The computer program product according to claim 27, wherein the first of the least one test cell is inserted into a non-functional library cell of the design.

29. The computer program product according to claim 22, further comprising:
a place-and-route process; and
a tape-out process,
wherein the inserting of a second of the at least one test cell is carried out after the place-and-route process and before the tape-out process.

30. The computer program product according to claim 29, wherein the second of the at least one test cell is inserted into a fill area of the circuit design.
